(19) United States
(12) Patent Application Publication
(10) Pub. No.: US 2013/0007645 A1
(43) Pub. Date: Jan. 3, 2013

(54) VISUAL TIME FILTER CONTROL TOOL FOR DATA ANALYSIS APPLICATIONS

(75) Inventors: Ricky Kurniawan, Edmonds, WA (US); Rajeev Karunakaran, Redmond, WA (US); Sujit Mathew Philip, Redmond, WA (US)

(73) Assignee: Microsoft Corporation, Redmond, WA (US)

(21) Appl. No.: 13/172,828

(22) Filed: Jun. 30, 2011

(51) Int. Cl. G06F 3/048

(52) U.S. Cl. 715/769; 715/810

(57) ABSTRACT

A visual time filter control (“VTFC”) tool enables a user to select one or more time periods for which the user desires to time filter data via a graphical user interface (“GUI”). According to one aspect, a computer-implemented method for filtering data by time includes displaying a GUI of a VTFC tool. The GUI includes a plurality of selectable time periods. The method further includes associating the VTFC tool with data, receiving a selection of one or more of the plurality of selectable time periods via the GUI of the VTFC tool, filtering the data in accordance with the selection to create a filtered dataset of the data, and displaying the filtered dataset.

### BACKGROUND

Time is an integral part of data analysis and data driven decisions. Various analysis techniques used by analysts, such as contribution analysis, consolidation analysis, and the like, all can benefit from filtering by time. Comparing data over time helps analysts to spot trends and to identify areas of optimization that ultimately drive better organizational performance and efficiency. Unfortunately, the tools made available to analysts are cumbersome to use, often requiring navigation of multiple menus and/or dialogues to filter data by time.

It is with respect to these and other considerations that the disclosure made herein is presented.

### SUMMARY

Concepts and technologies are described herein for visual time-based filtering for data analysis applications such as a spreadsheet application. In accordance with the concepts and technologies disclosed herein, a visual time filter control (“VTFC”) tool enables a user to select one or more time periods for which the user desires to time filter data via a graphical user interface (“GUI”). In some embodiments, the filtered data is co-displayed with the VTFC tool GUI within a spreadsheet document. The filtered data may be displayed in one or more graphical representations including various types of tables, charts, and graphs as discussed in greater detail herein.

According to one aspect, a computer-implemented method for filtering data by time includes displaying a GUI of a VTFC tool. The GUI includes a plurality of selectable time periods. The method further includes associating the VTFC tool with data, receiving a selection of one or more of the plurality of selectable time periods via the GUI of the VTFC tool, filtering the data in accordance with the selection to create a filtered dataset of the data, and displaying the filtered dataset.

According to another aspect, a computer-implemented method for filtering data by time includes displaying a GUI of a VTFC tool, the GUI including a time view, a filter label, and a parent label. The time view includes a plurality of selectable time periods, each of which is associated with one of a plurality of time labels, and each of which includes one of a year, a quarter, a month, and a day. The filter label identifies one or more of the plurality of time periods for which a timer filter has been applied via the VTFC tool. The parent label includes context for the plurality of time labels. The context includes a particular year if the plurality of time labels is months and a particular month if the plurality of time labels is days. The method further includes displaying a filtered dataset including data filtered via the time filter.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an exemplary operating environment for the various embodiments disclosed herein.

FIG. 2 is a flow diagram showing aspects of a method for filtering data by time utilizing a visual time filter control (“VTFC”) tool, according to an exemplary embodiment.

FIGS. 3A-3C are diagrams illustrating various graphical user interface (“GUI”) elements of an exemplary VTFC tool, according to exemplary embodiments.

FIG. 4 is a flow diagram showing aspects of a method for determining a focal time period, according to an exemplary embodiment.

FIGS. 5A-5D are diagrams illustrating GUI representations for various filter selection mechanisms, according to exemplary embodiments.

FIG. 6 is a diagram illustrating an exemplary spreadsheet including a VTFC tool and various graphical representations of a dataset filtered utilizing the VTFC tool, according to an exemplary embodiments.

FIG. 7 is a computer architecture diagram illustrating an exemplary computer hardware and software architecture for a computing system capable of implementing aspects of the embodiments presented herein.

### DETAILED DESCRIPTION

The following detailed description is directed to concepts and technologies visual time-based data filtering. According to the concepts and technologies described herein, a visual time filter control (“VTFC”) tool enables a user to select one or more time periods for which the user desires to time filter data via a graphical user interface (“GUI”).

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for visual time-based data filtering will be presented.

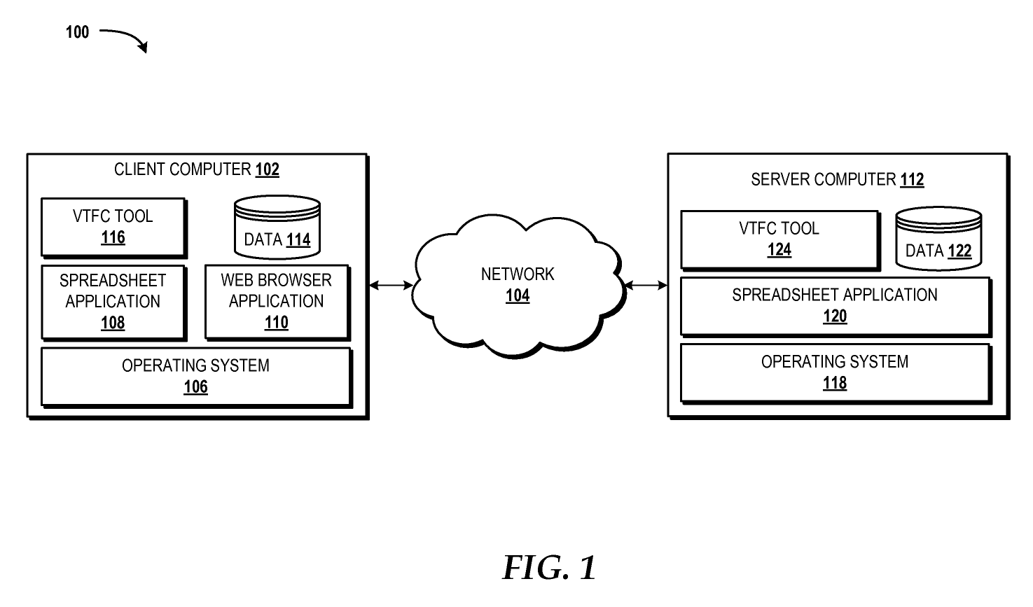

Referring now to FIG. 1, aspects of one operating environment 100 for the various embodiments presented herein will be described. The operating environment 100 shown in FIG. 1 includes a client computer 102 operating on or in communication with a network 104. The client computer 102 is configured to execute an operating system 106 and one or more application programs such as, for example, a spreadsheet application 108, a Web browser application 110, and/or one or more other applications. The network 104 may be an internet, an intranet, or an extranet. Access to the network 104 may be provided via one or more wired or wireless access networks (not shown), as will be understood by those skilled in the art.

The operating system 106 is a computer program for controlling the operation of the client computer 102. The application programs are executable programs configured to execute on top of the operating system 106 to provide various functionality described herein. The Web browser application 110 is an application program through which a user can access information resources on the World Wide Web (“the Web”) via the network 104. Moreover, the Web browser 110 allows a user to access information and various functions provided by a server computer 112 via one or more Web pages, as will be described in greater detail below.

The spreadsheet application 108 is an application program configured to display numerical data in cells in a simulated worksheet of rows and columns in which hidden formulas can perform calculations on data 114. Changing the contents of one cell can cause automatic recalculation of other cells. In some embodiments, the spreadsheet application 108 is a stand-alone application such as MICROSOFT EXCEL, available from Microsoft Corporation of Redmond, Wash., APPLE NUMBERS, available from Apple Inc. of Cupertino, Calif., OPENOFFICE CALC, available from Oracle Corporation of Redwood Shores, Calif., or the like. In some embodiments, the spreadsheet application 108 is part of an application suite such a MICROSOFT OFFICE, available from Microsoft Corporation of Redmond, Wash., APPLE IWORK, available from Apple Inc. of Cupertino, Calif., OPENOFFICE, available from Oracle Corporation of Redwood Shores, Calif., or the like. In some embodiments, the spreadsheet application 108 is configured to allow a user to embed a worksheet in another application such as a word processing application, a presentation application, a Web page design application, or the like.

The spreadsheet application 108 is configured to utilize a visual time filter control (“VTFC”) tool 116 to provide a visual and interactive way for a user to perform time-based filtering of the data 114. The data 114 includes any data that is associated with a time component. By way of example and not limitation, the data 114 may include sales data for Company X over a ten year or some other time period. In this example, a user may utilize the VTFC tool 116 to filter the data 114 so that only sales data for a specific date range, such as the last three years or the last fifteen months, is displayed. The data 114 may take various forms including, for example, numbers, letters, symbols, or some combination thereof. Moreover, the data 114 may be graphically represented as a chart. A chart is broadly defined herein as including bar charts, line charts, pie charts, histograms, timelines, area charts, bubble charts, waterfall charts, tables, pivot tables, pivot charts, maps, diagrams, 2-D graphs, 3-D graphs, and the like.

In some embodiments, the VTFC tool 116 is provided as part of the spreadsheet application 108. In other embodiments, the VTFC tool 116 is provided as an add-on or an add-in to the spreadsheet application 108 and/or another application, such as the Web browser application 110. Various aspects of the VTFC tool 110 are described in greater detail herein below.

The illustrated server computer 112 is configured to execute a server operating system 118 and one or more application programs such as, for example, a server spreadsheet application 120 and/or one or more other applications. The server operating system 118 is a computer program for controlling the operation of the server computer 112. The application programs are executable programs configured to execute on top of the server operating system 118 to provide various functionality described herein.

The server spreadsheet application 120, in some embodiments, is a Web-based application program configured to display numerical data in cells in a simulated worksheet of rows and columns in which hidden formulas can perform calculations on data 122. For example, the server spreadsheet application 120 may be a Web-based version of MICROSOFT EXCEL, available from Microsoft Corporation of Redmond, Wash., APPLE NUMBERS, available from Apple Inc. of Cupertino, Calif., OPENOFFICE CALC, available from Oracle Corporation of Redwood Shores, Calif., or the like. Alternatively, for example, the server spreadsheet application 120 may be an exclusively Web-based spreadsheet application such as GOOGLE SPREADSHEETS, available from Google of Mountain View, Calif. In some embodiments, the server spreadsheet application 120 is part of a Web-based application suite such a MICROSOFT OFFICE 365, available from Microsoft Corporation of Redmond, Wash., GOOGLE DOCS, available from Google of Mountain View, Calif., or the like. In any case, the server spreadsheet application 120 may be made available via one or more Web pages and may be accessed by a user via the Web browser application 110 of the client computer 102.

In some embodiments, the server spreadsheet application 120 is configured to allow a user to embed a worksheet in another application (Web-based or traditional) such as a word processing application, presentation application, Web page design application, or the like. In some embodiments, the server computer 112 is configured to execute the server spreadsheet application 120 and the client computer 102 is configured to access the server computer 112 to interact with the server spreadsheet application 120 in a client/server configuration. In these embodiments, the server spreadsheet application 120 may be identical to the spreadsheet application 108.

The server spreadsheet application 120 is configured to utilize a server VTFC tool 124 to provide a visual and interactive way for a user to perform time-based filtering of the data 122. The data 122 includes any data that is associated with a time component. By way of example and not limitation, the data 122 may include sales data for Company X over a ten year or some other time period. In this example, a user may utilize the server VTFC tool 124 to filter the data 122 so that only sales data for a specific date range, such as the last three years or the last fifteen months, is displayed. The data 122 may take various forms including, for example, numbers, letters, symbols, or some combination thereof. Moreover, the data 122 may be graphically represented as a chart.

In some embodiments, the server VTFC tool 124 is provided as part of the server spreadsheet application 120. In other embodiments, the VTFC tool 124 is provided as an add-on or an add-in to the server spreadsheet application 120 and/or another application (not shown) executing on the client computer 102 and/or the server computer 112. Various aspects of the server VTFC tool 124 are described in greater detail herein below.

According to various embodiments, the client computer 102 and/or the server computer 110 are personal computers (“PC”) such as desktop, tablet, or laptop computer systems. The client computer 102 and/or the server computer 110 may include other types of computing systems including, but not limited to, server computers, handheld computers, netbook computers, tablet computers, embedded computer systems, personal digital assistants, mobile telephones, smart phones, or other computing devices.

It should be understood that some implementations of the operating environment 100 include multiple client computers 102, multiple networks 104, and/or multiple server computers 112. It should also be understood that multiple operating systems 106, multiple spreadsheet applications 108, multiple Web browser applications 110, and/or multiple VTFC tools 116 may be used by the client computer 102; and multiple server operating systems 118, multiple server spreadsheet applications 120, and/or multiple VTFC tools 124 may be used by the server computer 112. Thus, the illustrated embodiments should be understood as being exemplary, and should not be construed as being limiting in any way.

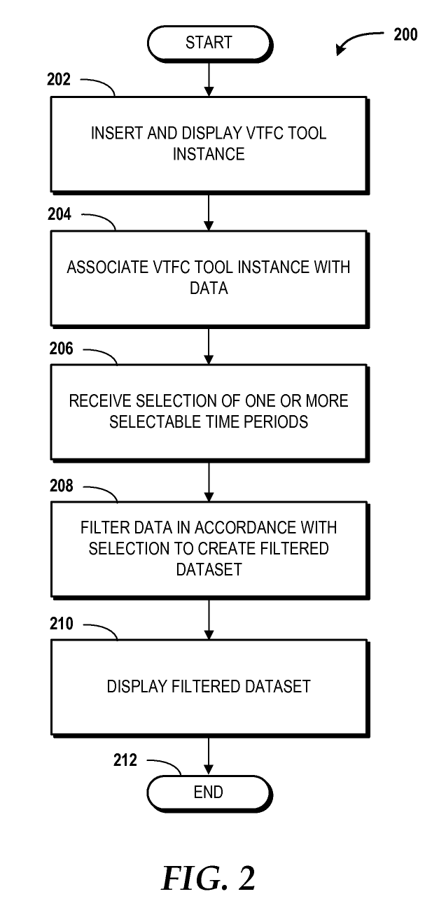

Turning now to FIG. 2, aspects of a method 200 for filtering data by time utilizing a VTFC tool such as the VTFC tool 116 or the server VTFC tool 124 will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the client computer 102 for ease of description, but may be alternatively or additionally performed by the server computer 112. It should be understood that these embodiments are exemplary, and should not be viewed as being limiting in any way.

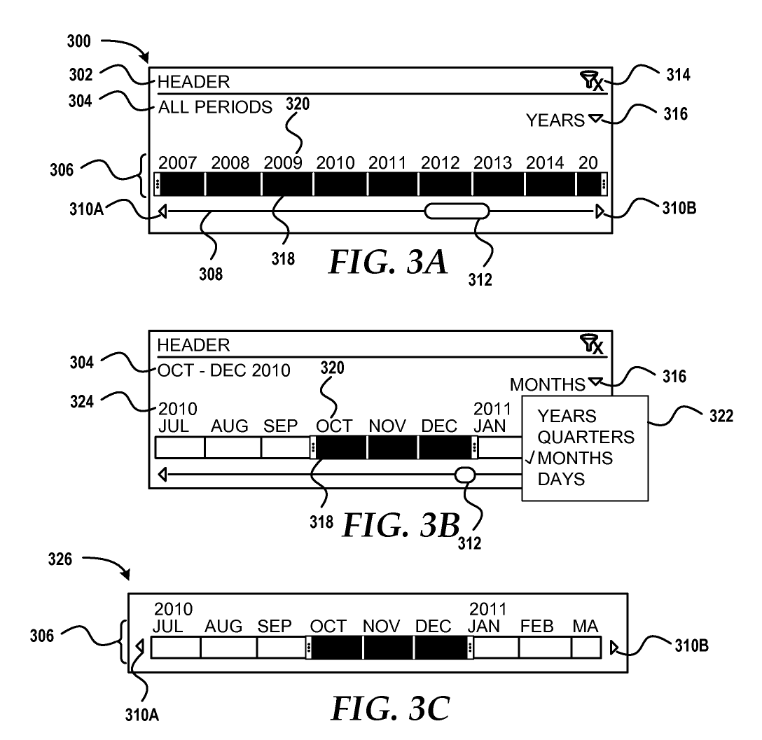

The method 200 begins at operation 202, wherein the client computer 102 inserts and displays an instance of the VTFC tool 116 within a document, such as a spreadsheet document created by the spreadsheet application 108. The VTFC tool 116 may include one or more GUI elements to facilitate performing the various operation of the method 200. An exemplary VTFC tool GUI 300 is illustrated and described below with reference to FIG. 3A-3C.

The VTFC tool 116 may be inserted in response to an insertion command provided by a user, or automatically in response to some other stimuli. For example, the VTFC tool 116 may be called by a script executed by the client computer 102. The insertion command may be facilitated by a user-selectable GUI element, such as an icon, which may be displayed in context of one or more other commands and may serve as an entry point for the VTFC tool 116. The GUI through which a user may select the VTFC tool 116 for insertion may be in any layout as determined, for example, by a developer. It is contemplated that the layout of this GUI may be customized by a user.

In some embodiments, the VTFC tool 116 is selectable for insertion via a ribbon interface. A ribbon interface is defined herein as an interface wherein commands are organized into logical groups that are collected together under one or more tabs. Each tab of the ribbon interface relates to a type of activity, such as filtering data (e.g., time filtering), writing, or laying out a document page (e.g., a spreadsheet, presentation slide, or word processing document). An exemplary ribbon interface is “the Ribbon” as utilized in various applications of the MICROSOFT OFFICE application suite. In some embodiments, the ribbon interface and/or one or more other GUI elements are contextual. In these embodiments, the ribbon interface and/or the one or more GUI elements are only displayed under certain circumstances, such as when the data 114 is on focus, upon mouse-over, upon selection of at least a portion of the data 114, or responsive to some other input or user action. Keyboard shortcuts, mouse clicks, right-clicks, single-touch, multi-touch, and gesture inputs are also contemplated as being capable of providing, alone or in some combination, an insertion command to insert an instance of the VTFC tool 116 at operation 202.

From operation 202, the method 200 proceeds to operation 204, wherein the VTFC tool 116 is associated with data (e.g., the data 114 and/or the data 122) on which a user desires to perform a time filtering operation. The data 114 is used hereinafter for convenience and ease of description.

In the illustrated embodiment, the user first inserts the VTFC tool 116 at operation 202 and then selects the data on which he or she desires to perform a time filtering operation to associate the VTFC tool 116 with the selected data at operation 204. In some embodiments, this association is performed simultaneously with the insertion in operation 202. Alternatively, a user may select the data on which he or she desires to perform a time filtering operation and then provide an insertion command for the VTFC tool 116 to associate the pre-selected data with an instance of the VTFC tool 116. In any case, the VTFC tool 116 is associated with the selected data.

In some embodiments, upon or after insertion of the VTFC tool 116, a list of all date dimensions in the data source is displayed. For example, the data source may include one or more date fields that each have a time component associated therewith. The list of all data dimensions may provide a means by which a user can select the one or more fields for association with the VTFC tool 116.

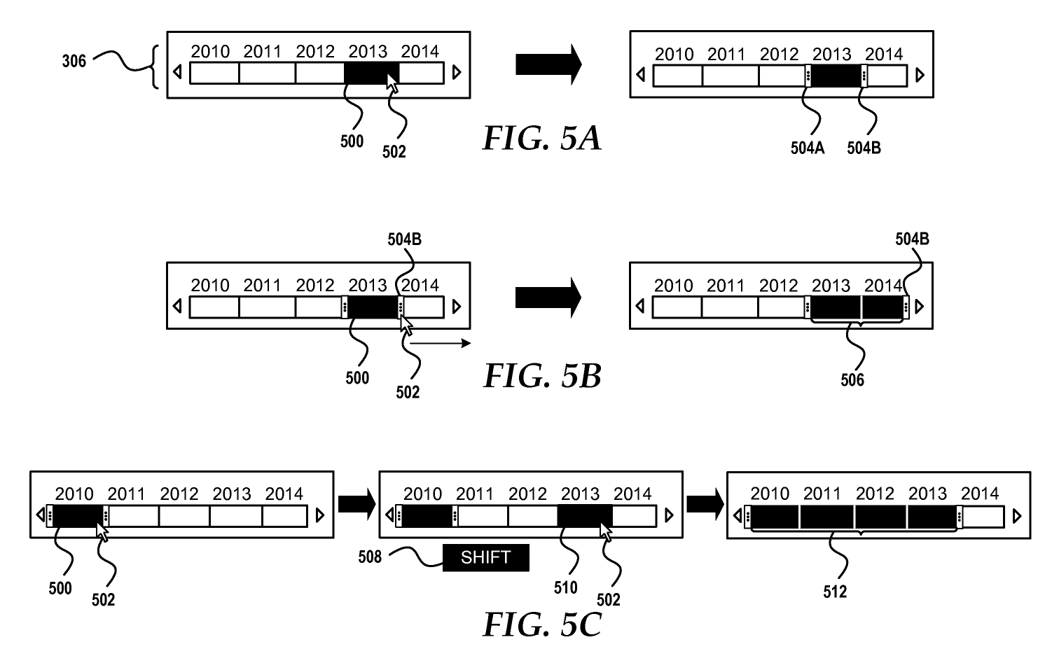

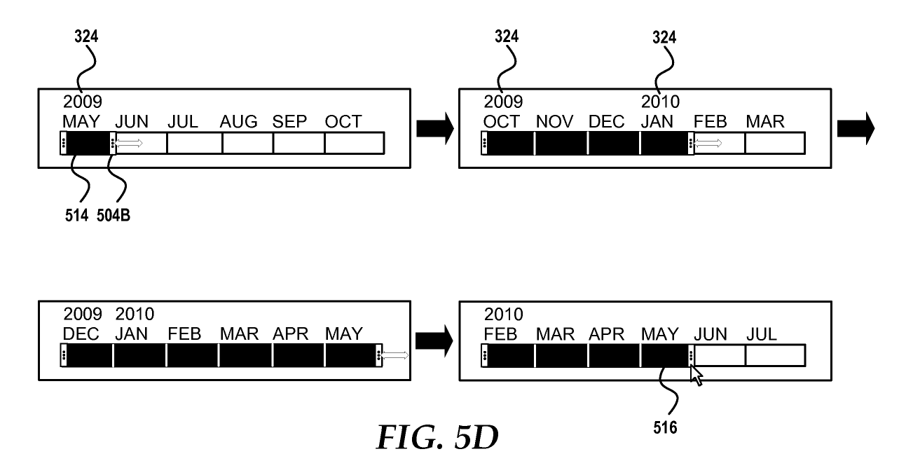

From operation 204, the method 200 proceeds to operation 206, wherein the VTFC tool 116 receives a selection of one or more selectable time periods for use in a time filtering operation. In some embodiments, each selectable time period is represented by a portion of a timeline, as best illustrated in FIGS. 3A-3C, and as described in greater detail below. Selection of one or more selectable time periods from the VTFC tool 116 may be performed via various selection mechanisms, as will be described in detail below with reference to FIGS. 5A-5D.

From operation 206, the method 200 proceeds to operation 208, wherein the data 114 is filtered in accordance with the selection received in operation 206 to create a filtered dataset. Operations 206, 208 may be repeated any number of times. For example, a user may select a first set of one or more selectable time periods and responsive to the first selection, the data 114 may be filtered to create a first filtered dataset; after which, the user may select a second set of one or more selectable time periods and responsive to the second selection, the data 114 may be filtered to create a second filtered dataset. Multiple filtering operations may result in a single filtered dataset, which may be a cumulative filtered dataset (e.g., a combined filtered dataset including a first filtered dataset and at least a second filtered dataset), the latest filtered dataset (in this example the second filtered dataset), or multiple discrete filtered datasets.

A new instance of the VTFC tool 116 may be created automatically in response to a second or greater filtering operation. For example, after a first filtering operation, if a user selects a second set of one or more selectable time periods, the spreadsheet application 108 or the VTFC tool 116 may be configured to prompt the user if he or she would like to create a new instance of the VTFC tool 116 for a second filtering operation or if he or she would like to replace the first filtering operation with the second filtering operation. It also is contemplated that further instances of the VTFC tool 116 may be created for further filtering an already-filtered dataset created at operation 208.

At operation 210, the filtered dataset is displayed. The filtered dataset, like the data 114, may take various forms including, but not limited to, numbers, letters, symbols, or some combination thereof. The filtered dataset may be additionally or alternatively graphically represented as a chart. Moreover, the filtered dataset may be displayed within the same viewable area of the spreadsheet in which the VTFC tool 116 was inserted, may be displayed within a different viewable area of the spreadsheet in which the VTFC tool 116 is not presently viewable, or may be exported to another spreadsheet within the same file as the spreadsheet (e.g., another tab) or another spreadsheet.

From operation 210, the method 200 proceeds to operation 212. The method 200 ends at operation 212.

Turning now to FIGS. 3A-3C, an exemplary VTFC tool GUI 300 for the VTFC tools 116, 124 will be described with reference to the VTFC tool 116 for convenience and ease of description. Referring particularly to FIG. 3A, the illustrated VTFC tool GUI 300 is an exemplary default GUI of an instance of the VTFC tool 116 as inserted, for example, at operation 202 of the method 200, described above. It is contemplated that the default GUI of the VTFC tool 116 may be modified by a user or a developer as needed for a particular implementation.

The illustrated VTFC tool GUI 300 includes a header 302, a filter label 304, a time view 306, a timespan bar 308, scrollers 310A, 310B, a scroll lens 312, a clear filter button 314, and a time level selector 316. These elements are now described in greater detail.

The header 302 identifies the VTFC tool GUI 300 with one or more characters such as letters, numbers, and/or symbols. The header 302, in some embodiments, is manually defined by a user such that a particular instance of the VTFC tool GUI 300 is identifiable to the user as being associated with certain data to be filtered via the VTFC tool 116. In other embodiments, the header 302 is automatically defined. For example, a name of a data source (e.g., the data 114 or a filename for a file in which the data 114 is included) or a data field being filtered by the VTFC tool 116 may be used to automatically define the header 302. The header 302 may include placeholder by default, such as the illustrated “HEADER” placeholder or some other default placeholder.

The filter label 304 identifies one or more time period(s) 318 for which a time filter is currently applied. In other words, the filter label 304 provides context for the current filter that is applied to selected data. The filter label 304 may be represented in various manners depending upon a time level of the time periods 318 of the time view 306. Various exemplary time levels are illustrated below in TABLE 1.

TABLE 1

| | | |
|---|---|---|
| YEAR granularity | One year selected | YYYY |
| | Range of years | YYYY <space> - |
| | selected | <space> YYYY |
| MONTH granularity | One month selected | MMM <space> YYYY |
| | Range of months | MMM <space> - |
| | selected (in the same | <space> M′M′M′ |
| | year) | YYYYY |
| | Range of months | MMM <space> YYYY - |
| | selected across | M′M′M′ <space> |
| | multiple years | Y′Y′Y′Y |
| DAY granularity | One day is selected | MMM <space> DD, |
| | | <space> YYYY |
| | Range of days - same | MMM <space> DD |
| | month, same year | <space> - D′D′, YYYY |
| | Range of days - | MMM <space> DD |
| | multiple months, | <space> - M′M′M′ |
| | same year | <space> D′D′, YYYY |
| | Range of days - | MMM <space> DD |
| | multiple months, | <space>, YYYY - |
| | multiple years | M′M′M′ <space> D′D′, |
| | | Y′Y′Y′Y′ |

In some embodiments, the filter label 304 is localizable to facilitate various regional settings so that the filter label 304 conforms to a user's regional settings and locale for displaying time in a particular date format. For example, if a user's regional settings are German (Germany), the filter label 304 may be displayed as “1.Jan 2011”; if the user's regional settings are English (United States), the filter label 304 may be displayed as “Jan 1, 2011”; or if the user's regional settings are Spanish (Mexico), the filter label 304 may be displayed as “1 de enero de 2011.” The user's regional settings may be provided by one or more of the operating systems 106, 118, the spreadsheet applications 108, 120, or the VTFC tools 116, 124. Other regional settings and date formats are contemplated.

In the illustrated embodiment of FIG. 3A, no filter is currently applied and, as such, the filter label 304 represents “ALL PERIODS.” This particular filter label may be the default filter label, although other default filter labels are contemplated including those defined or selected, for example, by a user or developer. If a single time period of the time periods 318 is selected, the filter label 304 may include a single date. The single date may include, for example, a month, a day, and a year in a particular date format. If multiple time periods of the time periods 318 are selected, the filter label 304 may include a range of time periods. The range of time periods may include, for example, a month and a year in a particular date format. This is best illustrated in FIG. 3B, wherein the filter label 304 includes “OCT-DEC 2010” to identify the selected time periods. The filter label 304 may be configured to change as the selected time period(s) is changed.

The time view 306 represents the number of time periods that can be viewed. The number of time periods that can be viewed may depend upon the horizontal width of the VTFC tool GUI 300. The horizontal width may be defined by a user and/or a developer. The horizontal width may alternatively be automatically adjusted to accommodate more or less time periods. For example, the horizontal width may be increased to accommodate data with a date range extending beyond a current set of viewable time periods. Alternatively, the size of each time period may be reduced to show a greater number of time periods within a given horizontal width. The orientation of the time view 306 may be changed such that the vertical height is configured to accommodate the time periods 318 in a stacked configuration.

The time view 306 is a timeline including the time periods 318, each of which represents a selectable time period that is particularly identified by a time label 320. The time labels 320 may include various time levels, for example, YEARS, QUARTERS, MONTHS, or DAYS, which may be changed using the time level selector 316. Time levels indicate a granularity level of the time labels 320.

As illustrated in FIG. 3B, the time level selector 316 includes a drop-down menu 322 via which a user can change the time level of the time labels 320. As used herein, increasing the granularity level of the time labels 320 refers to changing from a lower granularity time level (e.g., YEARS) to a higher granularity time level (e.g., QUARTERS, MONTHS, or DAYS). Similarly, decreasing the granularity level of the time labels 320 refers to changing from a higher granularity time level (e.g., MONTHS) to a lower granularity time level (e.g., YEARS). In the illustrated embodiment, YEARS is the lowest granularity for time levels and DAYS is the highest granularity for time levels.

It is contemplated that additional, alternative, or a completely different set of time levels may be used including, but not limited to, seconds, minutes, hours, decades, centuries, millennia, increments thereof, and the like. Custom time levels are also contemplated and may be defined by a developer and/or a user.

In the illustrated embodiment of FIG. 3B, a “MONTHS” time level has been selected and, accordingly, the time labels 320 are represented as months (i.e., July, August, September, etc.). Similarly, in FIG. 3A, a “YEARS” time level has been selected and, accordingly, the time labels 320 are represented as years (i.e., 2007, 2008, 2009, etc.).

In addition to the time labels 320, FIG. 3B illustrates a parent label 324. The parent label 324 provides additional context when looking at different time levels. The parent label 324 also helps indicate which year a particular month belongs to, or which month of year, a day belongs to. The parent label 324 may be used to convey other information based upon a given time level. In some embodiments, such as in the illustrated embodiment of FIG. 3A, there is no parent label 324 when YEARS is selected via the time level selector 316. The position of the parent label 324 is shown above and at the beginning of the time view 306, although alternative configurations are contemplated.

The illustrated VTFC tool GUI 300 can show a limited number of time periods at a time. Therefore, any change in time level granularity changes the time periods in view. This is best illustrated by FIG. 3A when the time level is YEARS and by FIG. 3B after the time level has been changed to MONTHS, effectively changing the time periods 318 from representing years as indicated by the time labels 320 to representing months. As described above, the size of the time periods 318 and/or the horizontal width of the VTFC tool GUI 300 may be changed to accommodate various numbers of time periods in a single viewable area.

The VTFC tool GUI 300 also includes the timespan bar 308. The timespan bar 308 provides a user with the ability to easily explore a timespan of a date field of the data (e.g., the data 114) to which it is connected. The timespan bar 308 provides, at a glance, the relative position of the time periods (e.g., the time periods 318) in view with respect to the total timespan.

The timespan bar 308 also provides a quick way to navigate to any area in the timespan including, for example, the minimum and the maximum ranges of a given time period. The timespan bar 308 also provides a quick pointer to navigate to a selected time period(s) if the selected time period(s) is not visible in the time view 306. This is useful when a user has a filter selection and browses away from that selection.

The timespan bar 308, in some embodiments includes a filter marker (not shown), which identifies a filter selection on the timespan bar 308 when the selected time period(s) associated with the filter selection is no longer in view. For example, the filter marker may be embodied as an overlay of at least a portion of the timespan bar 308. Clicking or otherwise selecting the overlay facilitates quick navigation back to a filter selection that is no longer in view.

In the illustrated embodiment, the timespan bar 308 includes the scrollers 310A, 310B at either end. The scrollers 310A, 310B enable incremental scrolling to the left and to the right, respectively. In some embodiments, the scrollers 310A, 310B are provided without the timespan bar 308. An example of this is illustrated in FIG. 3C, which shows a “no-frills mode” VTFC GUI 326 for the VTFC tool 116. As shown in FIG. 3C, the scrollers 310A, 310B are shown at either end of the time view 306. The “no-frills mode” VTFC GUI 326 may be toggled on/off via selection of a dedicated button (not shown) on the VTFC GUI 326 and/or within the spreadsheet application 108. Toggling of the “no-frills mode” VTFC GUI 326 may also occur automatically, for example, upon hover or whenever a user is not directly interacting with the VTFC GUI 326.

The scroll lens 312 allows for quick navigation and browsing of the time periods available in the timespan of the timespan bar 308. In the illustrated embodiment, the scroll lens 312 is positioned over a portion of the timespan bar 308. In some embodiments, the scroll lens 312 is viewable without the timespan bar 308 being viewable or vice versa. The scroll lens 312 and/or the timespan bar 308 may then become viewable upon hover or upon some other user interaction.

In some embodiments, the width of the scroll lens 312 represents the time periods 318 displayed in the time view 306 relative to the timespan of the data 114. For example, the scroll lens 312 shown in FIG. 3A is wider than the scroll lens 312 shown in FIG. 3B. The scroll lens 312 may include a minimum and/or a maximum width, which may be defined, for example, by a developer and/or a user. The width of the scroll lens 312, in some embodiments, is static.

The VTFC GUI 300 also includes the clear filter button 314. In the illustrated exemplary default configuration, the clear filter button 314 is positioned in the same horizontal portion of the VTFC GUI 300 as the header 302, but may be positioned in an alternative location. The clear filter button 314 allows a user to reset the filter applied and bring the filter controls of the VTFC tool 116 back to its default state. When no filter is applied, the clear filter button 314 may be disabled. The clear filter button 314 may be additionally or alternatively positioned as a GUI element of the spreadsheet application 108 (e.g., in a ribbon interface or menu).

Exemplary default states of various elements of the VTFC tool GUI 300 are summarized below in TABLE 2. Alternative, additional, or completely different default states are contemplated. Also, some of the elements may not be displayed at all per a default state. For example, the parent label 324 may not be displayed by default.

TABLE 2

| Element | Default state |
|---|---|
| Filter | All selected or no filter applied based upon implementation. |
| selection | If a date field of data has a default time member, the default |
| | member is selected. If the data has an existing filter prior to |
| | inserting an instance of the VTFC tool 116, then that filter |
| | is synced on the timeline after insertion. |
| Size | 350 × 125 pixels |
| Time level | YEARS level is displayed. |
| | Available levels: YEARS, QUARTERS, MONTHS, DAYS |
| Timespan | Begin Point starts from: first YEAR member of the date |
| | field dimension. |
| | End point ends with: last YEAR member of the date field |
| | dimension. |
| Scroll lens | Placed such that the current year is proportional to the |
| position | Timespan. |
| Time label | Current Year is displayed at the end. If cube doesn't have |
| | current year, then the last year in the cube is displayed at |
| | the end of the timeline control. |
| Filter label | Based on filter selection. If no filter is applied, the filter |
| | label is displayed as “All Periods”. |
| Parent label | None. Year does not have parent label. |
| Clear filter | Disabled |

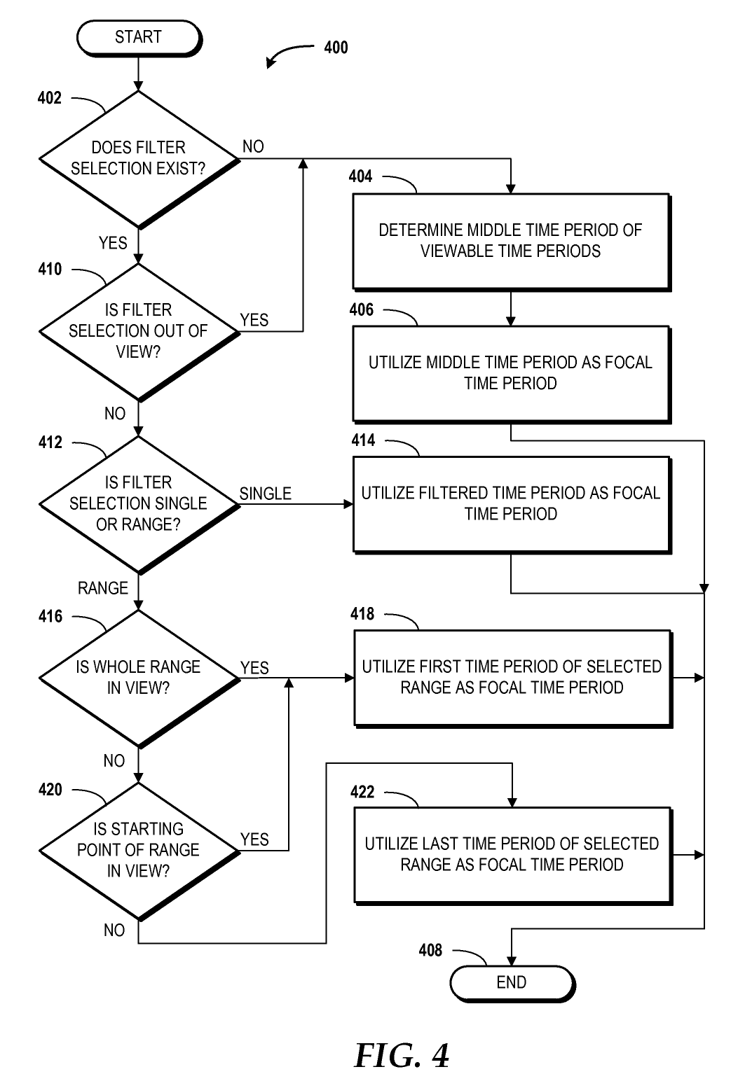

Turning now to FIG. 4, a method 400 for determining a focal time period based upon a number of viewable time periods will be described. In the embodiments illustrated in FIGS. 3A-3C, the time view 306 is configured to display a limited number of time periods 318 at a time. Therefore, any change in the granularity of the time level would change the time periods in view. In order to provide a predictable user experience for time level change and to avoid a user having to perform potentially cumbersome and repetitive scroll navigations, in some embodiments, for a time level change, a “focal time period” among the viewable time periods 318 is determined. The focal time period determines how a new granular time view is displayed. In some embodiments, as will be described below, the middle time period is selected as the focal time period. The middle time period may be the geometrical center of the time view 306, or may be an approximation of that center. In general, the middle time period is determined such that the focus is maintained as a predictable experience for when a filter selection does not exist. This helps a user to maintain a reasonable context of the time periods they view whenever a time level change occurs. The method 400 for determining the focal time period is now described.

The method 400 begins and proceeds to operation 402, wherein it is determined if a filter selection exists. If a filter selection does not exist (i.e., a user has not selected one or more of the time periods 318 by which to filter the data 114), the method 400 proceeds to operation 404, wherein a middle time period of the presently viewable time periods is determined. For example, the VTFC tool 116 determines which of the time periods 318 is positioned in the middle of the time view 306 (see FIG. 3A). This determination may be an approximation. From operation 404, the method 400 proceeds to operation 406, wherein the middle time period determined at operation 404 is utilized as the focal time period. The method 400 then proceeds to operation 408, wherein the method 400 ends.

If, however, it is determined at operation 402 that a filter selection does exist, the method 400 proceeds to operation 410, wherein it is determined if the existing filter selection is currently out of view. If the existing filter selection is currently out of view, the method 400 proceeds as above to operation 404, to operation 406, and then to operation 408, wherein the method 400 ends.

If, however, the existing filter selection is not currently out of view, the method 400 proceeds to operation 412, wherein it is determined if the existing filter selection identifies a single time period or a range of time periods. If the existing filter selection identifies a single time period, the method 400 proceeds to operation 414, wherein the filtered time period (i.e., the single time period) is utilized as the focal time period. The method 400 then proceeds to operation 408 and the method 400 ends.

If, at operation 412, the existing filter selection identifies a range of time periods, the method 400 proceeds to operation 416, wherein it is determined if the whole range of time periods is in view. If it is determined that the whole range is in view, the method 400 proceeds to operation 418, wherein the first time period of the range of time periods is selected as the focal time period. The method 400 then proceeds to operation 408 and the method 400 ends.

If it is determined, at operation 416, that the whole range of time periods is not in view, the method 400 proceeds to operation 420, wherein it is determined if the starting point of the range of time periods is in view. If the starting point of the range of time periods is in view, the method 400 proceeds to operation 418 as above and then to operation 408, wherein the method 400 ends. If, however, the starting point of the range of time periods is not in view, the method 400 proceeds to operation 422, wherein the last time period of the range of time periods is selected as the focal time period. The method 400 then proceeds to operation 408, wherein the method 400 ends.

Turning now to FIGS. 5A-5D, diagrams illustrating GUI representations for various filter selection mechanisms will be described, according to exemplary embodiments. Each of the illustrated GUI representations is shown in a no-frills mode as described above and without a parent label for ease of illustration and description and should not be construed as being limiting in any way.

Referring particularly to FIG. 5A, the time view 306 is illustrated including a plurality of selectable time periods of which a first time period 500 is being hovered over by a cursor 502. Upon hover over, a contrast color is shown to indicate that the first time period 500 is clickable. Upon clicking the first time period 500, the first time period 500 is selected. In the illustrated embodiment, the selection of the first time period 500 displays grip elements 504A, 504B at the beginning and at the end, respectively, of the first time period 500. The grip elements 504A, 504B provide a means by which a user can click and drag one or both sides of the first time period 500 to select one or more adjacent time periods.

The grip elements 504A, 504B may be automatically hidden from view in various situations. For example, the grip elements 504A, 504B may be automatically hidden when they are not hovered-over or otherwise not being interacted with, or when all or a portion of a VTFC tool GUI is not in focus.

Referring now to FIG. 5B, the grip element 504B is used to select a range of time periods 506. In particular, the grip element 504B is clicked and the cursor 502 is dragged to the right thereby selecting the immediately adjacent right-hand time period. Releasing the grip element 504B confirms the selection and results in the creation of the range of time periods 506.

Referring now to FIG. 5C, the first time period 500 is selected. After the first time period 500 is selected, a shift key 508 (e.g., hardware key or software key) is held down and a second time period 510 is selected with the cursor 502. Releasing the shift key 508 confirms the selection and results in the creation of a range of time periods 512.

Selection of multiple time periods may change the parent label 324 as the range of selected time periods is increased or decreased. By way of example, FIG. 5D illustrates a starting time period 514 at “2009” “MAY” is extended using the grip element 504B to an ending time period 516 at “2010” “MAY.” As a user extends the range of selected time periods into the YEAR 2010, the parent label 324 changes to further include the YEAR 2010. Moreover, extending further into the YEAR 2010 when the MONTHS from the YEAR 2009 are no longer viewable, the parent label 324 again changes to include the YEAR 2010 and remove the YEAR 2009 from view.

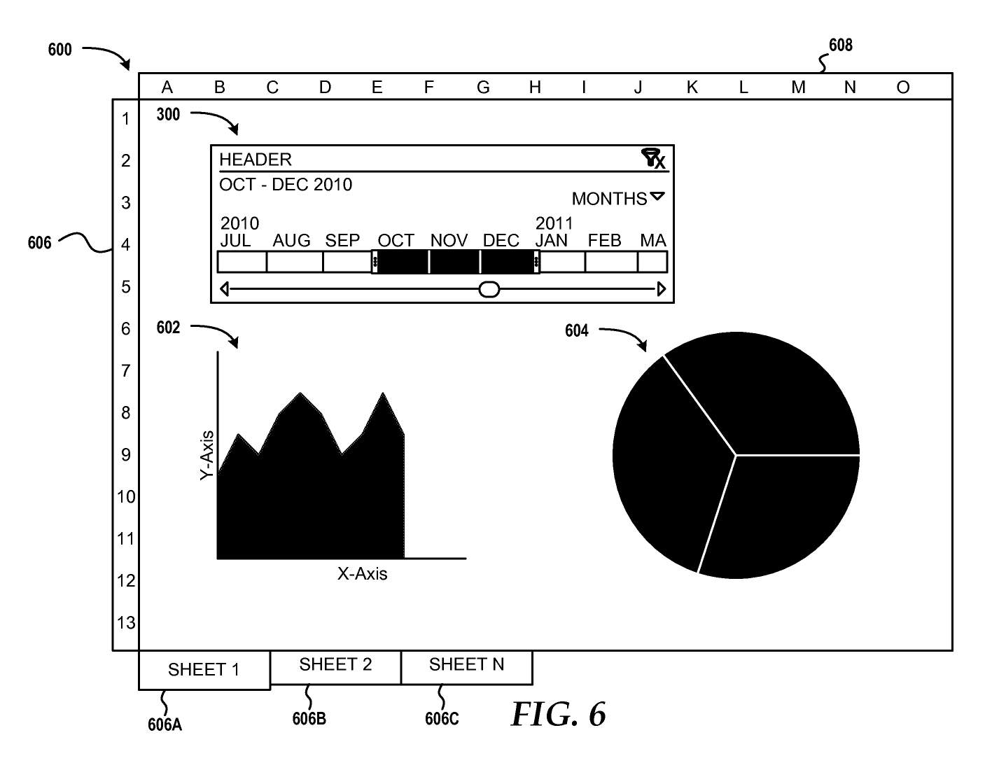

Turning now to FIG. 6, a diagram illustrating an exemplary spreadsheet 600 including the VTFC tool GUI 300 and various graphical representations 602, 604 of a dataset filtered utilizing the VTFC tool 116 will be described. The spreadsheet 600 includes a vertical scale 606 and a horizontal scale 608 as is typical of known spreadsheets. The spreadsheet 600 also includes tabs 606A-606C.

As disclosed above, the VTFC tool 116 may be used to time filter data sourced from a tab that is not currently in view. For example, the tab 606B or the tab 606C may contain the data 114 in table format from which the graphical representations 602, 604 are created. Filtering the data 114 using the VFTC tool GUI 300 manipulates the graphical representations 602, 604 to display graphics related to the filtered dataset. In the illustrated embodiment, the graphical representations 602, 604 are a line graph and a pie chart, respectively, although other types of graphical representations are contemplated.

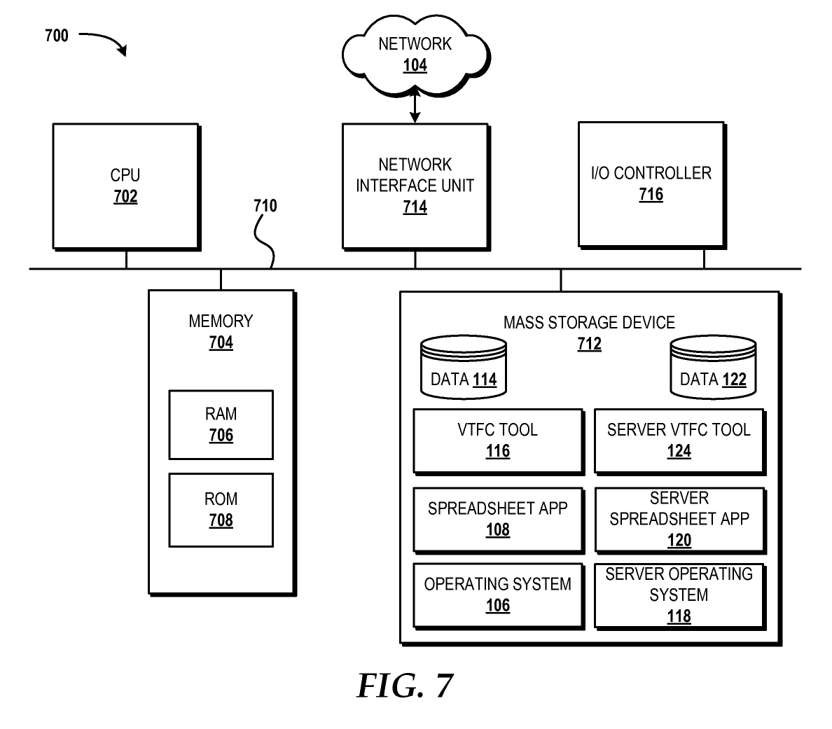

FIG. 7 illustrates an exemplary computer architecture 700 for a device capable of executing the software components described herein for time filtering data utilizing a VTFC tool. Thus, the computer architecture 700 illustrated in FIG. 7 illustrates an architecture for a server computer, mobile phone, a PDA, a smart phone, a desktop computer, a netbook computer, a tablet computer, and/or a laptop computer. The computer architecture 700 may be utilized to execute any aspects of the software components presented herein.

The computer architecture 700 illustrated in FIG. 7 includes a central processing unit 702 (“CPU”), a system memory 704, including a random access memory 706 (“RAM”) and a read-only memory (“ROM”) 708, and a system bus 710 that couples the memory 704 to the CPU 702. A basic input/output system containing the basic routines that help to transfer information between elements within the computer architecture 700, such as during startup, is stored in the ROM 708. The computer architecture 700 further includes a mass storage device 712 for storing the operating systems 106, 118, the spreadsheet applications 108, 120, the VTFC tools 116, 124, and the data 114, 122.

The mass storage device 712 is connected to the CPU 702 through a mass storage controller (not shown) connected to the bus 710. The mass storage device 712 and its associated computer-readable media provide non-volatile storage for the computer architecture 700. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 700.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 700. For purposes the claims, the phrase “computer storage medium” and variations thereof, does not include waves, signals, and/or other transitory and/or intangible communication media, per se.

According to various embodiments, the computer architecture 700 may operate in a networked environment using logical connections to remote computers through a network such as the network 104. The computer architecture 700 may connect to the network 104 through a network interface unit 714 connected to the bus 710. It should be appreciated that the network interface unit 714 also may be utilized to connect to other types of networks and remote computer systems, for example, remote computer systems configured to host data that is capable of being time filtered by the VTFC tools 116, 124. The computer architecture 700 also may include an input/output controller 716 for receiving and processing input from a number of other devices, including a keyboard, mouse, or electronic stylus (not shown in FIG. 7). Similarly, the input/output controller 716 may provide output to a display screen, a printer, or other type of output device (also not shown in FIG. 7).

It should be appreciated that the software components described herein may, when loaded into the CPU 702 and executed, transform the CPU 702 and the overall computer architecture 700 from a general-purpose computing system into a special-purpose computing system customized to facilitate the functionality presented herein. The CPU 702 may be constructed from any number of transistors or other discrete circuit elements, which may individually or collectively assume any number of states. More specifically, the CPU 702 may operate as a finite-state machine, in response to executable instructions contained within the software modules disclosed herein. These computer-executable instructions may transform the CPU 702 by specifying how the CPU 702 transitions between states, thereby transforming the transistors or other discrete hardware elements constituting the CPU 702.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 700 in order to store and execute the software components presented herein. It also should be appreciated that the computer architecture 700 may include other types of computing devices, including hand-held computers, embedded computer systems, personal digital assistants, and other types of computing devices known to those skilled in the art. It is also contemplated that the computer architecture 700 may not include all of the components shown in FIG. 7, may include other components that are not explicitly shown in FIG. 7, or may utilize an architecture completely different than that shown in FIG. 7.

Based on the foregoing, it should be appreciated that concepts and technologies for visual time-based filtering for data analysis applications have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer storage medium having computer readable instructions stored thereupon that, when executed by a computer, cause the computer to:
display a graphical user interface of a visual time filter control tool, the graphical user interface comprising a plurality of selectable time periods;
associate the visual time filter control tool with data;
receive a selection of one or more of the plurality of selectable time periods via the graphical user interface of the visual time filter control tool;
filter the data in accordance with the selection of the one or more of the plurality of selectable time periods to create a filtered dataset of the data; and
display the filtered dataset.

2. The computer storage medium of claim 1, wherein the selection of the one or more of the plurality of selectable time periods comprises the selection of the one or more of the plurality of selectable time periods via a click operation performed via an input device that is in communication with the computer.

3. The computer storage medium of claim 2, wherein the click operation performed via the input device is a single-click operation.

4. The computer storage medium of claim 2, wherein the click operation performed via the input device is a click-and-drag operation.

5. The computer storage medium of claim 2, wherein the click operation performed via the input device is a shift plus click operation.

6. The computer storage medium of claim 1, wherein the visual time filter control tool further comprises a time view in which the plurality of selectable time periods are shown, the time view comprising:
a plurality of time labels, each of which is associated with one or more of the plurality of selectable time periods, and each of which comprises one of a year, a quarter, a month, or a day; and
a parent label providing context for the plurality of time labels, the parent label comprising one of a year or a month.

7. The computer storage medium of claim 6, wherein the visual time filter control tool further comprises a time level selector via which a time level for the plurality of time labels is selected, the time level comprising one of years, quarters, months, or days.

8. The computer storage medium of claim 1, wherein the visual time filter control tool further comprises a filter label identifying the one or more of the plurality of selectable time periods selected to create the filtered dataset of the data.

9. A computer-implemented method for filtering data by time, the computer-implemented method comprising performing computer-implemented operations for:
displaying a graphical user interface of a visual time filter control tool comprising a plurality of selectable time periods;
associating the visual time filter control tool with data;
receiving a selection of one or more of the plurality of selectable time periods via the graphical user interface of the visual time filter control tool;
filtering the data in accordance with the selection of the one or more of the plurality of selectable time periods to create a filtered dataset of the data; and
displaying the filtered dataset.

10. The computer-implemented method of claim 9, wherein receiving the selection of the one or more of the plurality of selectable time periods comprises receiving the selection of the one or more of the plurality of selectable time periods via a click operation performed via an input device.

11. The computer-implemented method of claim 10, wherein the click operation performed via the input device is a single-click operation.

12. The computer-implemented method of claim 10, wherein the click operation performed via the input device is a click-and-drag operation, the click-and-drag operation being facilitated by at least one grip element.

13. The computer-implemented method of claim 12, wherein when the grip element is dragged beyond an edge of the plurality of selectable time periods, at least one additional selectable time period becomes viewable.

14. The computer-implemented method of claim 10, wherein the click operation performed via the input device is a shift plus click operation.

15. The computer-implemented method of claim 9, wherein the visual time filter control tool further comprises a time view in which the plurality of selectable time periods are shown, the time view comprising:
a plurality of time labels, each of which is associated with one or more of the plurality of selectable time periods, and each of which comprises one of a year, a quarter, a month, or a day; and
a parent label providing context for the plurality of time labels, the parent label comprising one of a year or a month.

16. The computer-implemented method of claim 15, wherein the graphical user interface further comprises a scroll lens configured to be selected and dragged to reveal additional selectable time periods that were not previously viewable in the time view.

17. The computer-implemented method of claim 15, wherein the visual time filter control tool further comprises a time level selector via which a time level for the plurality of time labels is selected, the time level comprising one of years, quarters, months, or days.

18. The computer-implemented method of claim 9, wherein the visual time filter control tool further comprises a filter label identifying the one or more of the plurality of selectable time periods selected to create the filtered dataset of the data.

19. The computer-implemented method of claim 9, further comprising simultaneously displaying the data and the visual time filter control tool within a spreadsheet.

20. A computer-implemented method for filtering data by time, the computer-implemented method comprising performing computer-implemented operations for:
displaying a graphical user interface of a visual time filter control tool, the graphical user interface comprising
a time view comprising a plurality of selectable time periods, each of which is associated with one of a plurality of time labels, and each of which comprises one of a year, a quarter, a month, or a day,
a filter label identifying one or more of the plurality of time periods for which a time filter has been applied via the visual time filter control tool, and
a parent label comprising context for the plurality of time labels, the context comprising a particular year if the plurality of time labels is months and a particular month if the plurality of time labels is days; and
displaying a filtered dataset comprising data filtered via the time filter, the filtered dataset being displayed in a chart.
